(19) United States
(12) Patent Application Publication
(10) Pub. No.: US 2019/0108768 A1
(43) Pub. Date: Apr. 11, 2019

(54) Driver Training System and Method

(71) Applicant: Farzan Mohamed, Baltimore, MD (US)

(72) Inventor: Farzan Mohamed, Baltimore, MD (US)

(21) Appl. No.: 16/168,616

(22) Filed: Oct. 23, 2018

Related U.S. Application Data
(63) Continuation-in-part of application No. 11/786,703, filed on Apr. 12, 2007, now abandoned.

(51) Int. Cl. G09B 9/052; G09B 19/14

(52) U.S. Cl. CPC G09B 9/052; G09B 19/14

(57) ABSTRACT

A software system and method provides driver training so that a student driver may gain knowledge and years of simulated driving experience prior to age 16 for passing a driver's license exam. The program comprises a game mode, an eye testing station, a driver's safety video, a written test, a driving simulation mode, an actual driving test by the state or county, and a vehicle selection mode.

### CROSS-REFERENCE TO RELATED APPLICATIONS

The present utility patent application is a continuation-in-part of U.S. patent application Ser. No. 11/786,703 filed 12 Apr. 2007.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to teaching individuals to drive and particularly to a pass or fail point system and software for driver training so that a student driver may gain years of simulation experience and knowledge for passing a driver's license exam, while preparing driver for real life on the road day to day driving situations with added scenarios and increase situational awareness as well as allowing experienced drivers to refresh their skills; the program comprises a game mode, an eye testing station, a driver's safety video, a written test utilizing the actual study book by state, a driving simulation mode utilizing live on-demand G.P.S technology, accident avoidance and pedestrian warning and lane change systems to include advance auto pilot systems an again the actual study book, an actual driving test utilizing G.P.S maps and street views technology so that user can use/drive the actual testing area layout by state or county prior to actually taking driving test, and a vehicle selection mode if applicable or if allowed by vehicle manufacturer while allowing an experienced driver to also refresh their skills; the program comprises a game mode, an eye testing station, a driver's safety video, a written test, a driving simulation mode, an actual driving test by the state or county, and a vehicle selection mode.

### Description of Related Art Including Information Disclosed Under 37 CFR 1.97 and 1.98

Teenage and other young new driver fatalities arising from auto related accidents are higher than any other group. Auto related accidents are the number one cause of teenage fatalities.

The main contributing factors to young driver fatalities include:
1. Not having enough driving experience as a new driver. (Not having enough defensive driving skills or road experience to avoid hazardous or harmful situations.)
2. Not wearing seat belts.
3. Eating or drinking when driving.
4. Traveling with other teens (distractions).
5. Talking on the cell phones while driving.
6. Adjusting the radio station or changing a CD.
7. Texting or reading Text while driving
8. Applying make-up while driving

A survey done in January 2006 by A.A.A. indicated that new drivers contribute 45% of all vehicular accidents. This is due to the fact that inexperienced drivers have not developed learned responses to emergency situations due to lack of experience. Driving simulators are known in the art which generate driving situations and impart them to the driver, to enable the driver to experience a feeling as if driving in real life.

A new driver by age sixteen cannot drive on the road prior to turning sixteen and therefore cannot gain the years of experience before getting behind the wheel. Prior art driver simulation devices do not provide sufficient depth or breadth or length of simulated driving experience to provide the driving instincts that years of driving provides. Prior driving simulators are antiquated, since road rules and technology changes from day to day.

Simulators for vehicle driving instruction are known in the prior art, such as U.S. Pat. Nos. D339,387; 3,657,457; 3,898,746; 3,916,534; 4,077,138; 4,383,827; 4,464,117; 4,750,888; 4,846,686; 4,939,587; 5,005,148; 5,044,956; 5,131,848; 5,184,956; 5,707,237 6,270,349; 6,431,872 and 6,652,376.

U.S. Patent Application #20060040239, published Feb. 23, 2006 by Cummins, describes a driving simulator having artificial intelligence profiles, replay, hazards, and other features. The driving simulator may include a processor; a display connectable to the processor; a plurality of input devices, such as a steering wheel, a brake pedal, and an accelerator pedal, where each of the plurality of input devices is connectable to the processor; and a computer-readable medium. The computer-readable medium contains instructions for providing a plurality of simulated driving environments, allowing a user to select one of the plurality of simulated driving environments, allowing a user to provide environment settings, allowing a user to select a simulated vehicle to operate, activating hazards, generating a plurality of simulated vehicles, generating a profile for each of the plurality of simulated intelligent vehicles; randomly assigning spawn points to each of the plurality of simulated intelligent vehicles, displaying the simulated driving environment to a user and allowing the user to operate the simulated vehicle in the simulated driving environment using the plurality of input devices, recording the operation of the simulated vehicle through the simulated driving environment, and replaying the operation of the vehicle. Evidence and history has proven that video games have and are currently being used to increase higher performance in different fields i.e. Pilots have and still uses video simulation as a way to higher education. The Armed forces also use video games as a way to train and get soldiers ready for combat and is evidenced in videos.

U.S. Patent Application #20040158476, published Aug. 12, 2004 by Blessinger, claims systems and methods for training students in a tripartite curriculum of ground vehicle learning. The tripartite curriculum includes computer based testing, training on a simulator, and instructor-led classroom training.

U.S. Pat. No. 5,259,623, issued Nov. 9, 1993 to Kanelos, discloses a board game teaching traffic laws and regulations and providing a peripheral playing path about the perimeter of a rectangular board and further inwardly located paths. The inwardly located paths are provided for the purpose of various examinations or tests to be under-taken by each player during the course of the game. The first player to successfully complete the written examination, eye examination, and road test portions of the game is declared the winner. However, other questions and requirements must be satisfactorily responded to during the portion of play which takes place along the peripheral playing path of the game board.

U.S. Pat. No. 7,426,437, issued Sep. 16, 2008 to Breed et al, puts forth an accident avoidance system for a host vehicle including a global positioning system residing on the host vehicle for determining the host vehicle's location as the host vehicle travels based on signals received from one or more satellites, a map database having digital maps corresponding to an area including the location of the host vehicle as determined by the global positioning system, a vehicle-to-vehicle communication system residing on the host vehicle operative for receiving signals including location information acquired by global positioning systems residing on other vehicles directly from the other vehicles indicating the locations of the other vehicles, and a navigation system including a display residing on the host vehicle for displaying images to an occupant of the host vehicle showing the digital maps and indications of the locations of the host vehicle and the other vehicles on the digital maps. The navigation system also updates the images shown on the navigation system display to reflect changes in the locations of the host vehicle and the other vehicles.

U.S. Patent Application #20040224740, published Nov. 11, 2004 by Ball, discloses a competitive simulation game comprising a base program and at least one controllable object controllable by a player, characterized in that, in use, a real time input from a real life game controls a competitive object in the competitive simulation game as a competitor to the player.

U.S. Patent Application #20020052724, published May 2, 2002 by Sheridan, indicates a hybrid vehicle operations simulator that uses an actual mobile vehicle whose operation is to be simulated, combined with computer-based image generation devices, and velocity, acceleration, and/or position measurement tools to improve the simulated operation of the vehicle, including perception of and response to hazards. Using the actual vehicle whose operation is to be simulated improves operator vestibular cues, visual cues, and motion fidelity, thereby producing a safer, less expensive means to produce the simulation.

U.S. Patent Application #20040259059, published Dec. 23, 2004 by Aoki, puts forth an interactive driving simulation apparatus for a two-wheeled vehicle wherein a real-time test drive performance by a student operator around a simulated driving route sequence is recorded. The recorded performance is later replayed for the benefit of the student, to provide real-world simulation, education, and performance evaluation. During the simulated driving, pre-recorded performance evaluation comments are selected and stored, corresponding to the student's specific performance at a traffic driving situation on the driving route sequence. Then, upon displaying of a replay screen image of the simulated driving on a display unit, when a particular traffic driving situation is arrived at, a simulated operating environment of the traffic driving situation and the selected performance evaluation comments are automatically superimposed and displayed together as a replay screen.

U.S. Patent Application #20050182632 published Aug. 18, 2005 by Niyamaru, concerns a simulation apparatus, comprising: a simulated vehicle operable by a driver; a speech recognition section for recognizing speech of the driver; and an outputting section for performing predetermined outputting based on the operation and the speech of the driver; wherein said speech recognition section automatically starts or stops the recognition of speech in response to a situation on simulated driving.

U.S. Pat. No. 4,486,180, issued Dec. 4, 1984 to Riley, is for a system for the administration of driver's tests and similar standardized tests has a computer control unit. A cathode ray tube (CRT) or other display is connected to the computer control unit by line. The display includes at least a numeric input keyboard connected to the remainder of the display by line. A camera or other portrait image registering device is connected to the computer control unit by line. A fingerprint image registering device is connected to the computer control unit by line. At least the display, the portrait image registering device and the fingerprint image registering device are located in a booth having a door. A switch or other detector for an open door prevents a test from being administered or continuing as long as the door is open. A vision testing device is connected to the computer control unit by line. Both a test of knowledge of a state's driving laws and a vision test may be administered by this system.

U.S. Pat. No. 6,227,862, issued May 8, 2001 to Harkness, provides a system and method for providing driver training and education particularly targeted towards teenage drivers. A system and method focus on six major areas that address both driving and lifestyle skills. The six major areas are i) lifestyle, ii) risk and benefit perception, iii) visual search, iv) speed adjustment, v) space management and vi) hazard recognition. The invention is directed to post licensing training and education. Content is embedded in a multi-faceted instructional framework using contemporary learning methods that work with teens using multi-media technologies and integrated and realistic subject matter utilizing three main components, namely workout sessions, computer based training (CBT) and parent-teen activity. The invented system and method encourages and enlists participation of the parents who are recognized as key agents in the development of safe driving practices. There is an ongoing assessment, which provides feedback for remediation. Further, certification provides additional incentive for learning.

U.S. Pat. No. 5,888,074, issued Mar. 30, 1999 to Staplin, shows a system for testing and evaluating driver situational awareness incorporates a device for displaying road and traffic images to a subject being tested, road and traffic image data for simulating operation of a vehicle to be outputted on the display device, instruction data to be outputted at least on the display device, input devices for inputting response data from the test subject in response to road and traffic image data generated on the display means, and a control device for controlling the operation of the system. The control device incorporates a vision test component for conducting a vision test of the subject and a driving reaction test component for conducting a driving reaction test of the subject. Each of the vision and driving reaction tests includes generating road and traffic image data for simulating operation of a vehicle, generating instruction data in coordination with the image data for providing instructions for the subject, monitoring for inputting of response data, and determining whether the inputted response data is correct or incorrect. The generated image data includes road and traffic video image data, test pattern image data and situation test image data. The test pattern image data is structured to test static visual acuity, static visual contrast sensitivity, dynamic visual acuity, dynamic visual contrast sensitivity and angular motion sensitivity. The situation test image data is structured to test divided attention capacity, selective attention capacity, attention switching, working memory functions, brake reaction time, and complex reaction time and decision making.

Four U.S. Pat. No. 5,366,376 issued Nov. 22, 1994; U.S. Pat. No. 5,368,484 issued Nov. 29, 1994; and U.S. Pat. Nos. 5,618,178 and 5,618,179 issued Apr. 8, 1997 to Copperman, claim a driver training system for a user of a simulated vehicle. The system includes input devices for controlling the simulated vehicle, a video display having three-dimensional graphics, modeling software for determining position information based on the input devices, atmospheric effects software to simulate time-of-day and weather conditions, and recursive training software to display a previous route through an environment simultaneously with a present route through the environment together with associated performance data. Another aspect of the recursive training software replays either the previous route or present route and controls one of the input devices to provide “hands-on” feedback to the user. The user then incrementally and recursively maximizes parameters associated with vehicle operation skill. The driver training system may be embodied as a vehicle simulator.

U.S. Pat. No. 5,573,402, issued Nov. 12, 1996 to Gray, describes a driver training system for a user of a simulated vehicle. The system includes input devices for controlling the simulated vehicle, a video display having three-dimensional graphics, modeling software for determining position information based on the input devices, atmospheric effects software to simulate time-of-day and weather conditions, and recursive training software to display a previous route through an environment simultaneously with a present route through the environment together with associated performance data. Another aspect of the recursive training software replays either the previous route or present route and controls one of the input devices to provide “hands-on” feedback to the user. The user then incrementally and recursively maximizes parameters associated with vehicle operation skill. The driver training system may be embodied as a vehicle simulator.

U.S. Pat. No. 5,607,308, issued Mar. 4, 1997 to Copperman, discloses a vehicle simulator with realistic operating feedback. A driver training system for a user of a simulated vehicle is provided which includes input devices for controlling the simulated vehicle, a video display having three dimensional graphics, a computer, modeling software for determining position information based on the input devices, atmospheric effects software to simulate time-of-day and weather conditions, and realistic operating feedback software for simulating on the input devices the feedback normally experienced with operating the vehicle. One aspect of the preferred embodiment is a system including a low frequency speaker mounted on an enclosure adjacent to the simulation user's seat through which road feel cues such as hitting an object are transmitted to the user in response to signals received from the computer. Another aspect of the invention is a system for simulating the feel to the user of anti-lock brakes on a brake pedal in response to signals received the computer.

Two U.S. Pat. No. 5,474,453 issued Dec. 12, 1995 and U.S. Pat. No. 5,660,547 issued Aug. 26, 1997 to Copperman, indicate a vehicle simulator containing a system for development of vehicle simulation scenarios. The vehicle simulation system includes simulated vehicle controls providing input signals to a computer, and feedback devices, including a video display, providing a user feedback on the operation and location of the simulated vehicle as it is driven through a simulated universe. One aspect of the invention is a scenario development system which uses the vehicle controls, the computer and the output devices to enable a scenario developer develop a simulation scenario which includes other programmed vehicles. The scenario developer can determine when and where the other programmed vehicles become active in a simulated universe in which the scenario takes place, as well as determine when and where the programmed vehicles leave the simulated universe. The scenario developer can also program the path of the programmed vehicles through the simulated universe by simply driving the programmed vehicles through the simulated universe using the vehicle controls and the feedback devices on the path that the scenario developer wishes the programmed vehicle to appear.

U.S. Pat. No. 6,361,321, issued Mar. 26, 2002 to Huston, puts forth a dynamically controlled vehicle simulator system, and methods of constructing and utilizing same. The system for simulating the operation of a vehicle comprises a monitor for displaying a sequence of visual images; a plurality of control devices for the simulated vehicle for manipulation by an operator of the simulated vehicle; a computer, responsive to manipulation of the simulated vehicle control devices, for presenting a temporal sequence of visual images to the operator on the monitor which depicts the operation of the simulated vehicle along a roadway in a simulated environment; a mechanism for dynamically controlling weather effects in the simulated environment; and a mechanism for creating a traffic event in the simulated environment on demand during a simulation session and presenting the traffic event to the operator substantially immediately thereafter.

U.S. Pat. No. 5,269,687, issued Dec. 14, 1993 to Mott, illustrates a driver training system for a user of a simulated vehicle. The system includes input devices for controlling the simulated vehicle, a video display having three-dimensional graphics, modeling software for determining position information based on the input devices, and recursive training software to display a previous route through an environment simultaneously with a present route through the environment. The user then incrementally and recursively maximizes parameters associated with vehicle operation skill. The driver training system may be embodied as an arcade game.

What is needed is a real life, live, on demand driver training system that anyone from ages 3 and above can use, utilizing G.P.S simulation of actual road maps, in addition to selected weather driving conditions related to testing and specific road locations including a combination of specifically focused options of vehicle choice and actual driving location with specific driving information and practice related to the actual driver testing at the location where the actual driving test will take place and a system which provides incentive for use and provides sufficient depth and breadth and length of simulated driving experience to provide the driving instincts that years of driving provides, and a virtual vehicle selecting and testing system to acquire skills for buying actual vehicles for sale.

### BRIEF SUMMARY OF THE INVENTION

It is a fact and all studies and statistics have proven that training and preparation in every situation is the key element to success. It is also a fact that a child mental ability or mind building process commences as early as age 3. Training anyone in any language in any environment from an early age is the key element to success and proficiency.

The present invention deals with the development of a new drivers mind, building confidence by dealing with real world, real life situations. Building knowledge and simulated experience dealing with every situation from changing a flat tire, changing oil on their vehicle, paying parking tickets, dealing with moving violations to utilizing Global Positioning Satellites (G.P.S.) and GOOGLE world/GOOGLE maps technology relating to teaching individuals to drive from the age of 3 while particularly focusing on a system, a systemic simulated system an approach thru software design for driver training, so that every student, every driver may gain years of driving knowledge and experience through simulation. Knowledge and experience that will give new license drivers a piece of mind for being safer drivers, not only in passing their driver's license exam, but in being safer driver experience drivers.

Prior to the present invention there were no proven system that shows a 16 year old can gain years of driving experience, driving to grandma's house or driving the actual drivers license test course prior to obtaining their drivers license.

The present invention also deals with refreshing older driver skills and making sure they are still road worthy; Airlines pilot must surrender their license at age 70. Auto drivers drive well into their 80's and 90's. The program of the present invention comprises a game mode, an eye testing station, a driver's safety video, a written test, a pass or fail point system driving simulation mode, driving anywhere utilizing g.p.s simulation, an actual driving test simulated by choosing the state or county were the driver resides, and a vehicle selection mode.

An object of the present invention is to provide a driver training system using simulation of actual driving conditions related to driver testing and specific road locations including a combination of specifically focused options of vehicle choice and actual driving location with specific driving information and practice related to the actual driver testing at the location where the actual driving test will take place and a system which provides incentive for use and provides sufficient depth and breadth and length of simulated driving experience to provide the driving instincts that years of driving provides and provide a virtual vehicle selecting and testing system to acquire skills for buying actual vehicles for sale.

Another object of the present invention is to train both new and senior citizen drivers to become more proficient in every aspects of driving so that by age 16, driving and defensive driving will become instinctual in every aspect of driving and in taking the actual written and or driving test.

A related object of the present invention is that by providing constant visualization of the actual layout of the testing area by State, County, City or Country, as well as utilizing on a day to day basis the actual study book on a pass/fail point system by state as a driver's safety video, and using the actual study book as a safety 4D driving simulation software video will make a user a proficient and experienced driver by age 16

A further object of the present invention is to provide a user with simulations of selecting, testing, and purchasing a vehicle to prepare the user for vehicle ownership.

In brief, a combined set of programs for driver training, proficiency acquisition, driver testing preparation, and vehicle selection and virtual road testing for purchase provides: 1. Breathalyzer test. 2. Eye Testing Station. 3. Driver's safety video (By Department of Transportation for that state). 4. Drug/alcohol testing video/training. 5. Choosing locality for simulation utilizing G.P.S and virtual maps. 6. Choosing vehicle for simulation. 7. Choosing Automatic or Standard shift driver training program. 8. Seat belt control (simulator will not engage without seat belt buckled). 9. GPS Game Mode virtual simulation of driving on actual road under various driving conditions including traffic, pedestrians, road hazards, various weather conditions, road conditions and other variables (using pass/fail point system). 10. Driving test practice instruction using virtual simulations of actual drivers license testing locations. 11. Written Test practice using actual drivers test questions using a drivers study book as a safety 3-D and 4-D video utilizing pass or fail point system commencing with 100 points. 12. Actual Drivers License test by State, County, City or Country utilizing the actual testing area layout by state, all in 3D and 4D Audio, Video compact disc high definition software. 13. Select actual vehicle for sale and virtually test drive the vehicle in the GPS Game Mode. 14. Select vehicle driver assist options and virtually test drive the vehicle with the options in the GPS Game Mode. 15. Virtual driver training manual for driver test location using vehicle with selected driver assist options in GPS Game Mode. 16. Virtual freestyle driving practice over selected GPS map routes. 17. Virtual freestyle driving over selected GPS Map Routes using selected driver assist options.

If a permit holder/new driver takes a virtual reality simulation test prior to obtaining a drivers license and if the user fails, scoring 70% or less, then it is evident upfront that this person is a risk without jeopardizing a single life or causing a single accident. Keep in mind that the simulation is based on the actual written test.

A primary advantage of the present invention is that many lives will be saved by training drivers properly including conditioning the drivers to respond effectively in emergency situations and developing good driving habits. The present invention focuses on reducing teenage accidents and road fatalities, and also provides a means for drivers of any age to brush up on their driving skills and driver safety awareness.

Another advantage of the present invention is that a driver will be thoroughly prepared for taking a driving test to obtain a drivers license.

One more advantage of the present invention is to provide a user with simulations of selecting, testing, and purchasing a vehicle to prepare the user for vehicle ownership.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of the series of programs of the system of the present invention.

### DETAILED DESCRIPTION OF THE INVENTION

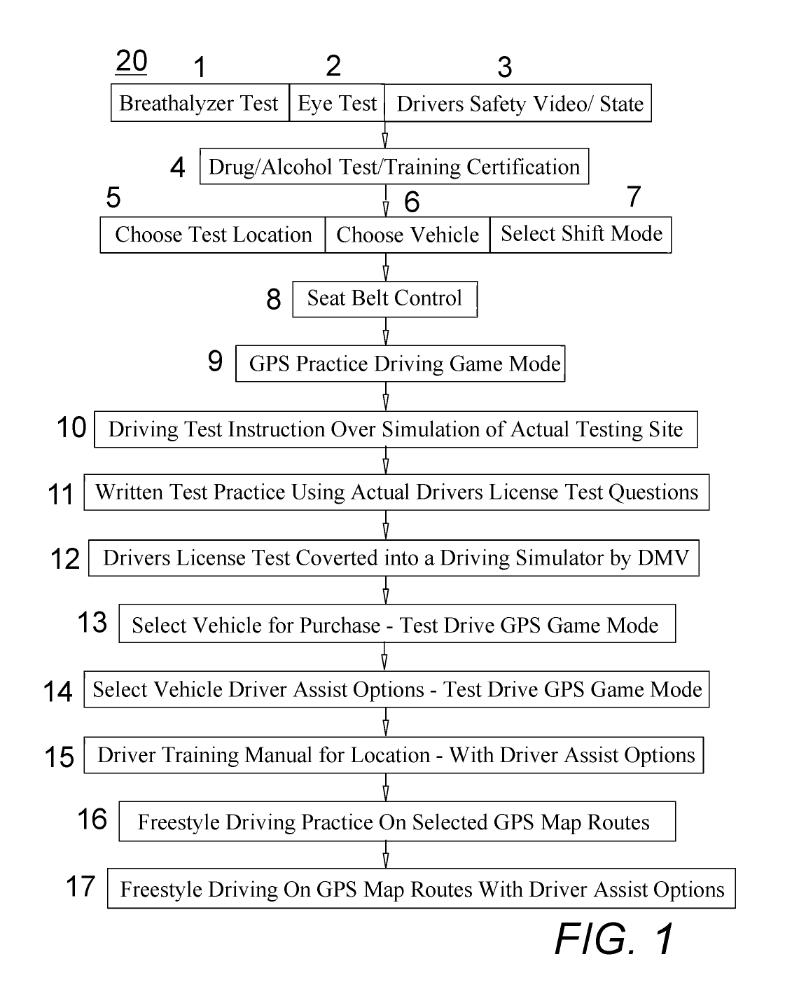

In FIG. 1, a driver training system 20 provides a series of integrated software programs for complete simulation and practice of driving and driver testing and vehicle selection and virtual testing for purchase to provide incentive for use and sufficient depth and breadth and length of simulated driving experience to provide the driving instincts that years of driving provides.

The present invention provides a comprehensive driver training and driver testing system 20 of integrated software programs for simulation and practice of driving experiences and driver license testing experiences for a user's geographical location to insure safe driving habits prior to actually receiving a drivers license and provide driver performance evaluation and driver's license testing and grading practice to insure passing the driver's local licensing test for individual state or country utilizing an actual testing book.

As shown in FIG. 1, the system of the present invention provides a combined set of programs for driver training, proficiency acquisition, driver testing preparation, and vehicle selection and virtual road testing for purchase provides: 1. Breathalyzer test. 2. Eye Testing Station. 3. Driver's safety video (By Department of Transportation for that state). 4. Drug/alcohol testing video/training. 5. Choosing locality for simulation utilizing G.P.S. (Global Positioning System) and virtual maps with road level travel virtual video imaging. 6. Choosing vehicle for simulation. 7. Choosing Automatic or Standard shift driver training program. 8. Seat belt control (simulator will not engage without seat belt buckled). 9. GPS Game Mode virtual simulation of driving on actual road under various driving conditions including traffic, pedestrians, road hazards, various weather conditions, road conditions and other variables (using pass/fail point system). 10. Driving test practice instruction using virtual simulations of actual drivers license testing locations. 11. Written Test practice using actual drivers test questions using a drivers study book as a safety 3-D and 4-D video utilizing pass or fail point system commencing with 100 points. 12. Actual Drivers License test by State, County, City or Country utilizing the actual testing area layout by state, all in 3D and 4D Audio, Video compact disc high definition software. 13. Select actual vehicle for sale and virtually test drive the vehicle in the GPS Game Mode. 14. Select vehicle driver assist options and virtually test drive the vehicle with the options in the GPS Game Mode. 15. Virtual driver training manual for driver test location using vehicle with selected driver assist options in GPS Game Mode. 16. Virtual freestyle driving practice over selected GPS map routes. 17. Virtual freestyle driving over selected GPS Map Routes using selected driver assist options.

As illustrated in FIG. 1, the system comprises in combination:

Integrated software programs adapted for use in an electronic device having input and output devices to simulate any of a variety of user selected driving experiences, driver licensing testing and grading for a user's geographical location, and virtual selecting, testing and purchasing a vehicle, the integrated software programs comprising:

A simulated breathalyzer test experience program 1 to reduce drunk driving accidents and road fatalities;

A simulated eye testing program 2 having a digital reader to enable the user to undergo a simulation of an accurate simulation of a vision test prior to taking the actual vision test to obtain a drivers license;

A driver safety video program 3 furnished by the user's state Department of Transportation, which enables a user to watch to see what can actually happen if driving under the influence, distraction while driving, not following highway laws etc;

A drug and alcohol testing video program 4 to educate users in safe driving habits and educates drivers on safe drug-free and alcohol-free driving;

A drivers license testing location selection program 5 for the user to select a state, city, county, and country where the user's actual drivers license testing will take place;

A testing vehicle selection program 6 and 7 for the user to select a vehicle and license class shift mode for taking the driving test;

A seat belt control program 8 requiring the user to buckle up a seat belt in order to activate an ignition system of the driving simulation program; A driving simulation program 9 comprising a driving simulation GPS game mode, the driving simulation program adapted to carry out enforcement of state and country driving laws including tickets and driving points issued for not following chosen state driving laws, the program adapted for a user to engage in hours of simulated driving practice to develop habits of driver safety and defensive driving, the program further adapted to evaluate the user's simulated driving performance using a pass/fail point system; the simulated driving video gaming program 9 having a driving simulator comprising an actual 3D/4D street type driving program for any selected state, city, and county taken from global positioning system maps and videotaped street views adapted for providing the user with the virtual opportunity to practice driving over any user selected driving locations for a variety of driving experiences to provide sufficient depth and breadth and length and variety of simulated driving experiences to provide driving instincts equivalent to years of actual driving to insure safe driving habits prior to actually receiving a driver's license and a working knowledge of driving over routes in advance of actually being able to drive over the routes and utilizing a pass/fail point system to evaluate the simulated driving experiences of the user taking into account applicable laws of the selected state and taking into account various driving road conditions and hazardous situations encountered in driving;

A simulated driving video gaming program 9 simulating driving on an actual trip over a route the user may want to travel by selecting a location from the global positioning system maps and videotaped street views adapted for providing the user with the virtual opportunity to practice driving over the simulated route, which may be the driver's license testing route, prior to actually visiting that location including inputting weather conditions from a projected weather forecast for the route allowing the user to practice driving over the route under the projected driving conditions on the day of travel, and a pass/fail point system to evaluate the user's simulated driving performance;

An instructional program 10 providing point by point instructions about the actual driving test at a user's driver testing location to simulate an actual driver testing location for a user to practice driving over the testing location;

A simulated written driver license test program 11 replicating a written driver license test given by the user's state or country, the written driver license test program adapted for the user to gain practice in taking the written driver license test, and receive an electronically generated grade on test performance using a pass or fail grading system;

An actual Drivers License test program 12 provided by State, County, City or Country utilizing the actual testing area layout by state, all in 3D and 4D Audio, Video compact disc high definition software; the simulated driving test video gaming program having a driving simulator comprising an actual 3D/4D street type driving program for a selected state, city, and county taken from global positioning system maps and videotaped street views adapted for providing the user with the experience of carrying out a driving test simulation of the actual location of the actual driving test and utilizing a pass/fail point system to evaluate the simulated driving test taken by the user taking into account applicable laws of the selected state and taking into account various driving road conditions and hazardous situations encountered in driving; and A vehicle selection, testing, and purchasing program 13 for selecting an actual vehicle available for purchase to take virtual test drives utilizing a game developed LEGO or logo type vehicle and added driver assist options program 14 for virtual practice to select, test, and practice using all the driver assistance technologies offered by the vehicle manufacturer, including lane change warning systems, accident avoidance systems, adaptive cruise control, pedestrian warnings, accident mitigation systems, lane change warning system, navigation system, rear camera, auto pilot, voice command, automatic seat belt lock, and other optional systems unique to the selected vehicle; and a simulated driving video gaming program simulating driving the selected vehicle over any selected route taken from global positioning system maps and videotaped street views and programmed selected driving conditions adapted for providing the user with the virtual experience of driving the selected vehicle over the selected route, and a pass/fail point system to evaluate the user's simulated driving performance;

A virtual driver training manual program 15 for driver test location using vehicle with selected driver assist options in GPS Game Mode;

A virtual freestyle driving practice program 16 over selected GPS map routes for users to take any virtual trips over any video simulations of driving anywhere they like to get practice driving by taking a wide variety of virtual driving trips;

A virtual freestyle driving program 17 over selected GPS Map Routes using selected driver assist options to gain practice in driving over a variety of roads utilizing the various driver assist options offered by vehicle manufacturers;

Thereby providing a comprehensive driver training and testing system of integrated software programs for simulation and practice of driving experiences over selected routes and driving conditions and driver license testing experiences for a user's geographical location to insure safe driving habits prior to actual driving and provide testing and grading practice to insure passing the user's local driver licensing tests, and gain virtual practice in selecting, testing, and purchasing a vehicle.

The system wherein the simulated driving video gaming program simulates driving on an actual trip over a route taken from global positioning system maps and videotaped street views comprises a program adapted for simulating smooth traveling over the street views at user input speeds and user input actions of braking and stopping and turning along the route.

The system wherein the electronic device comprises at least one of a variety of electronic devices taken from the list of electronic devices including a computer, a personal computer, a hand-held computer, a tablet, a dedicated programmable electronic device, a gaming device, a smart phone.

The system may further comprise a stand-alone vehicle replica with all features and operational functions of a real vehicle interconnected with a global positioning satellite program and screen to simulate driving on actual roadways.

The system wherein the driving conditions comprise at least one of the following conditions including hazardous roadway conditions, hazardous roadway situations including bad drivers, inside vehicle distractions, road rage drivers and different climate conditions.

The system wherein the inside vehicle distractions comprise teenagers driving with other teenagers, adjusting radio stations, changing CDs, eating, talking and texting on cell phones.

Some programs may offer a bypass optional breathalyzer test to make a user aware of how the test works and can actually be used to reduce drunk driving accidents and road fatalities. This part of the system focuses mainly on preventing someone from driving if they had too much to drink. For example, if people are having a party at their house and someone had too much to drink, but the people are not sure if the drinker should be driving. The drinker will now be able to walk over to the game of the present invention and take an actual breathalyzer test.

Some programs may offer a bypass optional eye testing station with a digital reader enables the user to undergo an actual eye test at the user's convenience, just like taking an eye examination either at the Optometrist or at Department of Motor Vehicles to help the user in the early stages or phases of life as well as trying to obtain or renew their driver's license.

The test location selection program 5 allows a user to select a state, city, county, and country where actual testing will take place. After selection of country, city or state the actual layout of the testing area can be viewed or selected to enable a user to do the actual driving test with ease when the actual testing day arrive. Knowing the actual topography layout will give user the advantage since driving the actual layout as a game many times in the simulation.

The choosing vehicle program 6 enables the user to make a selection of a vehicle and license class, which might include the audio, video compact disc software/game will allow the user to select or purchase the vehicle of choice for state licensing. For example, after installation of software a world map would appear with a drop down of State, province or Country. The user will be able to select the country, city, county or state that he or she wishes to pursue a driver's license. After that selection another picture selection of an automatic vehicle, stick shift car, light truck, 18 wheeler, van, boat, forklift, motor cycle or other vehicle will appear for selection.

With each selection, the class will also appear. For example, Class D licensing for cars, small truck and vans. There will also be a selection of a Big Rig for C.D.L heavy duty trucking, selection of a motor cycle for Class C, selection of a boat for boating or captain license, and selection of a forklift for licensing.

A standard transmission driver training program 7 educates a user in shifting a standard shift vehicle. There will be a special emphasis on stick shift and handicap vehicles. For instance, shift now, a flashing light on the dash will remind you to shift: “Be careful you might burn the clutch if you do not shift on time.” (Software will assist and advised user when shifting is necessary.) The seat belt control 8 requires a user to buckle up a seat belt in order to activate the system and the program will not engage in any aspect until the seat belts is fasten. This required fastening of a seat belt to use the system if practiced in the game mode by users from age 5 to 16, when the user does obtain a drivers license at age 16, buckling the user's seat belt will become automatic.

The driving test may be converted into a driving simulator 12 comprises an actual 3D street type driving program by selection of state, city, county to produce a simulation of the actual location of the real driving test and utilizing a pass/fail point system taking into account applicable laws to the state chosen and other driving road conditions and hazardous situations encountered in driving. The driving conditions may comprise at least one of the following conditions including hazardous roadway conditions, hazardous roadway situations including bad drivers, inside vehicle distractions, and different climate conditions. The s inside vehicle distractions may comprise teenagers driving with other teenagers, adjusting radio stations, changing CDs, eating, and talking on cell phones.

The actual written test/study book test from each city, state, county, country is transformed into an actual drivers safety video game utilizing a pass/fail point system. The user will begin by using a life-like driving simulator in our program with 100 points being allocated. Points will be deducted for being pulled over by a police officer. At which time a citation will be issued as well as a fine being imposed on driver. Each time a citation is issued, the user will also have additional points deducted from his/her drivers license at which time the drivers license can also be revoked. Points and revocation of license will be the same as in the state chosen.

Points are deducted each time a user fails to follow the safety requirements of that state (for example not pulling over if an emergency vehicle with flashing lights is behind the vehicle) This is done so that the user will have a first hand, true life visual of that state's actual written test and what follows in terms of consequences if safety and defensive methods are not utilized when driving. This will allow the user to gain years of defensive driving experience, again conditioning the user in being familiar with the written test as well as any safety regulations mandated by the state to help the user to understand how to or when to apply the actual state written test in their real life driving experience, so that in the event of an actual emergency or if situations do arise, the user will have effective driving defensive instinct from the simulation/training which will automatically kick in, since they have done this so many times for so many years in the simulations. By user choice, when the user reaches a 70 point mark, the game will cancel causing the user to fail the drivers test and the game must be restarted. The game can be restarted at the point of failure.

The global positioning satellite (G.P.S) game mode 9 comprises using a G.P.S. program to simulate an/the actual roadway at a selected location and further comprises programmed driving conditions, and a pass/fail point system to evaluate performance in driving over the roadways. This enables a user to become more familiar with areas that are not familiar to the user. By utilizing G.P.S technology along with the software of the present invention, the user can now simulate the actual drive prior to driving down a roadway. For example, a user is going to be traveling to Las Vegas and renting a car at the airport. After renting a vehicle the user will be driving to the M.G.M Grand hotel. The user can now practice and drive the actual streets by utilizing the virtual reality simulator and simulate the actual drive while also getting familiar with the actual highways and streets. This feature will not just save lives but will expedite the actual trip. A pass/fail point system is also part of this simulation program so a user can become more proficient on safety and road regulations.

The present invention enables a user to simulate actual diving experiences while gaining years of defensive driving experience prior to actually driving.

The system may further comprise a stand-alone vehicle replica with all features and operational functions of a real vehicle interconnected with a global positioning satellite program and screen to simulate driving on actual roadways.

In addition to the written test simulation program, special emphasis will focus on repeated simulated experience so that automatic responses will kick in when actual dangerous driving situations do arise in an actual vehicle.

In addition to the written test an optional safety video can be viewed of other unsafe situation simulations will be added such as when driving along side an 18 wheeler carrying logs, the logs suddenly brake loose, entering a tunnel when the sun is at the height of the tunnel therefore while entering there is a blind spot just as the driver enters but there is a stalled vehicle in your lane, coming out of a parking lot or side street with no visual site line of oncoming traffic due to parked cars blocking the driver's view. The present invention includes an audio video 3D/4D game version game program that can be use on any existing Play Station, Game Boy, X-Box, Nintendo 64, Desk top or Lap top Computer, pda devices, smart phone, tablet or preferable on a Fisher price like kind and quality arcade toy car or go cart design to either move with powered wheels or just as a standalone unit equipped with a 5″ to 9″ monitor, DVD player or built in computer hard drive.

The program can produce a Virtual Reality Simulator style (3 and 4 D life like graphics) utilizing a pass/fail no tampering point system. The software design setup may allow a user's choice to selection levels 1-10, depending on the previous passing of the levels (levels cannot be bypassed unless selected by the driver). The Method of the Present Invention Comprises:

A comprehensive driver training and testing method using integrated software programs for simulating and practicing driving experiences and driver license testing experiences for a user's geographical location for providing sufficient depth and breadth and length of simulated driving experiences and providing driving instincts equivalent to years of actual driving insuring safe driving habits prior to actual driving and providing testing and grading practice to insure passing the driver's local licensing test, and selecting and testing a vehicle for purchase, the method comprising in combination:

providing integrated software programs in an electronic device having input and output devices simulating any of a variety of user selected driving experiences and simulating driver licensing testing and grading for a user's geographical location, the integrated software programs comprising:

taking a simulated breathalyzer test using a breathalyzer test program to reduce drunk driving accidents and road fatalities;

taking a simulated eye test using an eye testing program having a digital simulation of an eye testing chart to simulate of an actual eye test prior to taking the actual vision test to obtain a drivers license;

observing a driver safety video program furnished by a driver's state Department of Transportation;

observing a drug and alcohol testing video program to educate drivers in safe driving;

selecting a state, city, county, and country where the user's actual testing will take place using a selection program communicating with global positioning system maps and videotaped street views;

selecting a vehicle and a license class using a vehicle and license class program for the user to select a vehicle and license class;

fastening a simulated seat belt using a seat belt control program requiring a user to buckle up a seat belt in order to activate a driving simulation program;

simulating driving using a video gaming program having a driving simulator comprising an actual 3D/4D street type driving program for any selected state, city, and county taken from global positioning system maps and videotaped street views providing the user with the virtual opportunity to practice driving over any user selected driving locations for a variety of driving experiences to provide sufficient depth and breadth and length and variety of simulated driving experiences to provide driving instincts equivalent to years of actual driving to insure safe driving habits prior to actually receiving a driver's license and developing a working knowledge of driving over routes in advance of actually being able to drive over the routes and utilizing a pass/fail point system to evaluate the simulated driving experiences of the user taking into account applicable laws of the selected state and taking into account various driving road conditions and hazardous situations encountered in driving;

simulating driving using a video gaming program simulating driving on an actual trip over a route the user may want to travel by selecting a location from the global positioning system maps and videotaped street views providing the user with the virtual opportunity to practice driving over the simulated route, which may be the driver's license testing route, prior to actually visiting that location including inputting weather conditions from a projected weather forecast for the route allowing the user to practice driving over the route under the projected driving conditions on the day of travel, and a pass/fail point system evaluating the user's simulated driving performance;

studying an instructional program providing point by point instruction about the actual driving test;

simulating taking a driver's license written test using a simulated written driver's license test program replicating the written driver license test given by the user's state or country, and electronically generating a grade on test performance using a pass or fail grading system;

simulating taking a driver's license driving test using a driving test video gaming program having a driving simulator comprising an actual 3D/4D street type driving program for a selected state, city, and county taken from global positioning system maps and videotaped street views providing the user with the experience of carrying out a driving test simulation of the actual location of the actual driving test and utilizing a pass/fail point system to evaluate the simulated driving test taken by the user taking into account applicable laws of the selected state and taking into account various driving road conditions and hazardous situations encountered in driving and

selecting an actual vehicle using a program for selecting an actual vehicle available for purchase, virtually test driving the vehicle, and utilizing a game developed LEGO or logo type vehicle to see view and utilize all the functionally offered by the vehicle manufacturer, including lane change warning systems, accident avoidance systems, adaptive cruise control, pedestrian warnings, accident mitigation systems, lane change warning system, navigation system, rear camera, auto pilot, voice command, automatic seat belt lock, and other systems unique to the selected vehicle; and simulating driving the selected vehicle using a video gaming program simulating driving the selected vehicle over any selected route taken from global positioning system maps and videotaped street views and programmed selected driving conditions for providing the user with the virtual experience of driving the selected vehicle over the selected route, and evaluating the simulated driving performance using a pass/fail point system;

thereby providing a comprehensive driver training and testing method using integrated software programs for simulating and practicing driving and driver license testing for a user's geographical location and developing driving instincts and defensive driving habits equivalent to years of actual driving insuring safe driving habits prior to actual driving and providing testing and grading practice to insure passing the user's local driver licensing tests, and virtual experience in selecting and testing a vehicle for purchase.

The method wherein simulating driving using the video gaming program simulating driving on an actual trip over a route taken from global positioning system maps and videotaped street views comprises using a program adapted for simulating smooth traveling over the street views at user input speeds and user input actions of braking and stopping and turning along the route.

The method wherein providing an electronic device comprises providing at least one of a variety of electronic devices taken from the list of electronic devices including a computer, a personal computer, a hand-held computer, a tablet, a dedicated programmable electronic device, a gaming device, a smart phone.

The method further comprises providing a stand-alone vehicle replica with all features and operational functions of a real vehicle interconnected with a global positioning satellite program and screen to simulate driving on actual roadways.

The method wherein the driving conditions comprise at least one of the following conditions including hazardous roadway conditions, hazardous roadway situations including bad drivers, inside vehicle distractions, and different climate conditions.

The method wherein the inside vehicle distractions comprise teenagers driving with other teenagers, adjusting radio stations, changing CDs, eating, talking and texting on cell phones.

In use, in the game program, the new driver will be allowed 100 points. When the driver fail to follow that state required safety study book safety video while driving simulation style, for example not wearing seat belts, not pulling over if an emergency vehicle approaching, not moving into another lane when an emergency vehicle/police pulled over a vehicle points will be deducted. Overtaking, while driving up a hill points will be deducted. Changing a flat tire around a corner or up or down a hill point will be deducted. A new driver obtaining a learners permit must have a passing score of 75% with 100% being the highest.

If driver fail the virtual driving test, a re-testing must be re-scheduled. And before the simulated license is awarded the same proposed driver utilizing the same virtual simulator taking the same simulation test must have a passing score of 95%. Making this mandatory before a new driver gets his or her driver's license is sure to decrease teen age accidents and road fatalities. This program if utilized before a new driver's license is issued is guaranteed to save lives.

The software 3-D/4D type graphic design program of the present invention will add years of driving experience to any driver, since it is a proven fact that “practice makes perfect”. And since the tamper free no fault point system of the present invention is accurate.

The user will be able to select the different types of license they wish to obtain by selecting the State or Country, utilizing and taking the actual written sample test as well as visualization in taking the actual driving test in a 3D/4D mode simulation. The present invention will be for all ages. Ages 3 to 13 years can use the same pass or fail point system program as a game on the play mode by selecting various highways in the city, states, county or country or they wish to drive. A selection for weather climate can be chosen.

Ages 14 to 16 years can use the game mode of the present invention as a simulation mode to practice defensive driving, since the present invention converts and utilizes the actual book study questions into a 3-D/4D driving simulator or just to study for the upcoming written test. Ages 35, 40 or 50 years of age can use this game to brush up their driving skills while keeping up with new state or international laws.

Whether a user is just looking for entertainment on the play mode, acquiring a new learner's permit and or just renewing or brushing up on current laws or legislation changes, this CD program/software game will assure hours of fun and entertainment while insuring parents that through the present invention no tampering point system their child have undergone the many hours of defensive training which will now add years of experience to a new driver by age 16 without leaving the house.

The software of the present invention will also be voice activated for the handicapped as well as being able to select specially designed handicap vehicles.

In the driving modes the driver or user will be given driving tips. For example, when driving in the snow, the user will be prompted to lower air pressure for better traction. For better gas mileage check tire pressure for no more than recommended tire pressure. How to change a tire or where the tire and/or jack are located in their vehicle. How to change or check oil or how to pay for parking or moving violations tickets.

A user at user option can purchase a vehicle from the software simulation present invention mode or actually link to local car dealers web page and simulate a purchase. The user at user option can now select the type of vehicle they desire.

Or if sponsorship by a particular vehicle manufacturer, the user will only be able to purchase that manufacturer vehicle by going the actual dealer web site by state and viewing inventory.

It is understood that the preceding description is given merely by way of illustration and not in limitation of the invention and that various modifications may be made thereto without departing from the spirit of the invention as claimed.

What is claimed is:

1. A comprehensive driver training and driver testing system of integrated software programs for simulation and practice of driving experiences and driver license testing experiences and vehicle purchasing and test driving for a user's geographical location to insure safe driving habits prior to actually receiving a drivers license and provide driver performance evaluation and driver's license testing and grading practice to insure passing the driver's local licensing test utilizing an actual testing book and vehicle testing, selection, and purchasing practice, the system comprising in combination:
integrated software programs adapted for use in an electronic device having input and output devices to simulate any of a variety of user selected driving experiences and driver licensing testing and vehicle selection and testing including grading for a user's geographical location, the integrated software programs comprising:
a simulated breathalyzer test experience program to reduce drunk driving accidents and road fatalities;
a simulated eye testing program having a digital reader to enable the user to undergo a simulation of an accurate simulation of a vision test prior to taking the actual vision test to obtain a drivers license;
a driver safety video program furnished by the user's state Department of Transportation;
a drug and alcohol testing video program to educate users in safe driving habits;
a program for the user to select a state, city, county, and country where the user's actual testing will take place;
a program for the user to select a vehicle and license class;
a driving simulation program comprising a driving simulation game mode, the driving simulation program adapted to carry out enforcement of state and country driving laws including tickets and driving points issued for not following chosen state driving laws, the program adapted for a user to engage in hours of simulated driving practice to develop habits of driver safety and defensive driving, the program further adapted to evaluate the user's simulated driving performance using a pass/fail point system;
a seat belt control program requiring the user to buckle up a seat belt in order to activate an ignition system of the driving simulation program;
a simulated driving video gaming program having a driving simulator comprising an actual 3D/4D street type driving program for any selected state, city, and county taken from and/or actually using/partnering with a G.P.S leader using their (G.P.S) global positioning system maps and videotaped street views adapted for providing the user with the virtual opportunity to practice driving over any user selected driving locations for a variety of driving experiences to provide sufficient depth and breadth and length and variety of simulated driving experiences to provide driving instincts equivalent to years of actual driving to insure safe driving habits prior to actually receiving a driver's license and a working knowledge of driving over routes in advance of actually being able to drive over the routes and utilizing a pass/fail point system to evaluate the simulated driving experiences of the user taking into account applicable laws of the selected state and taking into account various driving road conditions and hazardous situations encountered in driving;
a simulated driving video gaming program simulating driving on an actual trip over a route the user may want to travel by selecting a location from the global positioning system maps and videotaped street views adapted for providing the user with the virtual opportunity to practice driving over the simulated route, which may be the driver's license testing route, prior to actually visiting that location including inputting weather conditions from a projected weather forecast for the route allowing the user to practice driving over the route under the projected driving conditions on the day of travel, and a pass/fail point system to evaluate the user's simulated driving performance;
an instructional driver training manual program providing point by point instructions about the actual driving test at a user's driver testing location;
a simulated written driver license test program replicating a written driver license test given by the user's state, province or country, the written driver license test program adapted for the user to gain practice in taking the written driver license test, and receive an electronically generated grade on test performance using a pass or fail grading system;
a simulated driving test video gaming program having a driving simulator comprising an actual 3D/4D street type driving program for a selected state, city, and county taken from global positioning system maps and videotaped street views adapted for providing the user with the experience of carrying out a driving test simulation of the actual location of the actual driving test and utilizing a pass/fail point system to evaluate the simulated driving test taken by the user taking into account applicable laws of the selected state and taking into account various driving road conditions and hazardous situations encountered in driving and
a program for selecting an actual vehicle available for purchase, virtually test driving the vehicle, and utilizing a game developed LEGO or logo type vehicle to see view and utilize all the driver assistance technologies offered by the vehicle manufacturer, including lane change warning systems, accident avoidance systems, adaptive cruise control, pedestrian warnings, accident mitigation systems, lane change warning system, navigation system, rear camera, auto pilot, voice command, automatic seat belt lock, and other optional systems unique to the selected vehicle; and a simulated driving video gaming program simulating driving the selected vehicle over any selected route taken from global positioning system maps and videotaped street views and programmed selected driving conditions adapted for providing the user with the virtual experience of driving the selected vehicle over the selected route, and a pass/fail point system to evaluate the user's simulated driving performance;
thereby providing a comprehensive driver training and testing system of integrated software programs for simulation and practice of driving experiences over selected routes and driving conditions and driver license testing experiences for a user's geographical location to insure safe driving habits prior to actual driving and provide testing and grading practice to insure passing the user's local driver licensing tests, and vehicle testing and purchasing simulations to practice selecting and acquiring a vehicle.

2. The system of claim 1 wherein the simulated driving video gaming program simulating driving on an actual trip over a route taken from global positioning system maps and videotaped street views comprises a program adapted for simulating smooth traveling over the street views at user input speeds and user input actions of braking and stopping and turning along the route.

3. The system of claim 1 wherein the electronic device comprises at least one of a variety of electronic devices taken from the list of electronic devices including a computer, a personal computer, a hand-held computer, a tablet, a dedicated programmable electronic device, a gaming device, a smart phone.

4. The system of claim 1 further comprising a stand-alone vehicle replica with all features and operational functions of a real vehicle interconnected with a global positioning satellite program and screen to simulate driving on actual roadways.

5. The system of claim 1 wherein the driving conditions comprise at least one of the following conditions including hazardous roadway conditions, hazardous roadway situations including bad drivers, inside vehicle distractions, road rage drivers and different climate conditions.

6. The system of claim 5 wherein the inside vehicle distractions comprise teenagers driving with other teenagers, adjusting radio stations, changing CDs, eating, talking and texting on cell phones.

7. A comprehensive driver training and testing method using integrated software programs for simulating and practicing driving experiences and driver license testing experiences for a user's geographical location for providing sufficient depth and breadth and length of simulated driving experiences and providing driving instincts equivalent to years of actual driving insuring safe driving habits prior to actual driving and providing testing and grading practice to insure passing the driver's local licensing test, and vehicle selecting, testing and purchasing practice, the method comprising in combination:
providing integrated software programs in an electronic device having input and output devices simulating any of a variety of user selected driving experiences and simulating driver licensing testing and grading for a user's geographical location, the integrated software programs comprising:
taking a simulated breathalyzer test using a breathalyzer test program to reduce drunk driving accidents and road fatalities;
taking a simulated eye test using an eye testing program having a digital simulation of an eye testing chart to simulate of an actual eye test prior to taking the actual vision test to obtain a drivers license;
observing a driver safety video program furnished by a driver's state Department of Transportation;
observing a drug and alcohol testing video program to educate drivers in safe driving;
selecting a state, city, county, and country where the user's actual testing will take place using a selection program communicating with global positioning system maps and videotaped street views;
selecting a vehicle and a license class using a vehicle and license class program for the user to select a vehicle and license class;
fastening a simulated seat belt using a seat belt control program requiring a user to buckle up a seat belt in order to activate a driving simulation program;
simulating driving using a video gaming program having a driving simulator comprising an actual 3D/4D street type driving program for any selected state, city, and county taken from global positioning system maps and videotaped street views providing the user with the virtual opportunity to practice driving over any user selected driving locations for a variety of driving experiences to provide sufficient depth and breadth and length and variety of simulated driving experiences to provide driving instincts equivalent to years of actual driving to insure safe driving habits prior to actually receiving a driver's license and developing a working knowledge of driving over routes in advance of actually being able to drive over the routes and utilizing a pass/fail point system to evaluate the simulated driving experiences of the user taking into account applicable laws of the selected state and taking into account various driving road conditions and hazardous situations encountered in driving;
simulating driving using a video gaming program simulating driving on an actual trip over a route the user may want to travel by selecting a location from the global positioning system maps and videotaped street views providing the user with the virtual opportunity to practice driving over the simulated route, which may be the driver's license testing route, prior to actually visiting that location including inputting weather conditions from a projected weather forecast for the route allowing the user to practice driving over the route under the projected driving conditions on the day of travel, and a pass/fail point system evaluating the user's simulated driving performance;
studying an instructional program providing point by point instruction about the actual driving test;
simulating taking a driver's license written test using a simulated written driver's license test program replicating the written driver license test given by the user's state or country, and electronically generating a grade on test performance using a pass or fail grading system;
simulating taking a driver's license driving test using a driving test video gaming program having a driving simulator comprising an actual 3D/4D street type driving program for a selected state, city, and county taken from global positioning system maps and videotaped street views providing the user with the experience of carrying out a driving test simulation of the actual location of the actual driving test and utilizing a pass/fail point system to evaluate the simulated driving test taken by the user taking into account applicable laws of the selected state and taking into account various driving road conditions and hazardous situations encountered in driving and
selecting an actual vehicle using a program for selecting an actual vehicle available for purchase and utilizing a game developed LEGO or logo type vehicle to see view and utilize all the functionally offered by the vehicle manufacturer, including lane change warning systems, accident avoidance systems, adaptive cruise control, pedestrian warnings, accident mitigation systems, lane change warning system, navigation system, rear camera, auto pilot, voice command, automatic seat belt lock, and other systems unique to the selected vehicle; and simulating driving the selected vehicle using a video gaming program simulating driving the selected vehicle over any selected route taken from global positioning system maps and videotaped street views and programmed selected driving conditions for providing the user with the virtual experience of driving the selected vehicle over the selected route, and evaluating the simulated driving performance using a pass/fail point system;
thereby providing a comprehensive driver training and testing method using integrated software programs for simulating and practicing driving and driver license testing for a user's geographical location and developing driving instincts and defensive driving habits equivalent to years of actual driving insuring safe driving habits prior to actual driving and providing testing and grading practice to insure passing the user's local driver licensing tests and experience in selecting, testing and purchasing a vehicle.

8. The method of claim 7 wherein simulating driving using the video gaming program simulating driving on an actual trip over a route taken from global positioning system maps and videotaped street views comprises using a program adapted for simulating smooth traveling over the street views at user input speeds and user input actions of braking and stopping and turning along the route.

9. The method of claim 7 wherein providing an electronic device comprises providing at least one of a variety of electronic devices taken from the list of electronic devices including a computer, a personal computer, a hand-held computer, a tablet, a dedicated programmable electronic device, a gaming device, a smart phone.

10. The method of claim 7 further comprises providing a stand-alone vehicle replica with all features and operational functions of a real vehicle interconnected with a global positioning satellite program and screen to simulate driving on actual roadways.

11. The method of claim 7 wherein the driving conditions comprise at least one of the following conditions including hazardous roadway conditions, hazardous roadway situations including bad drivers, inside vehicle distractions, and different climate conditions.

12. The method of claim 11 wherein the inside vehicle distractions comprise teenagers driving with other teenagers, adjusting radio stations, changing CDs, eating, talking and texting on cell phones.
